(19) United States
(12) Patent Application Publication
(10) Pub. No.: US 2023/0394323 A1
(43) Pub. Date: Dec. 7, 2023

(54) PERSONALIZED FEDERATED LEARNING VIA HETEROGENEOUS MODULAR NETWORKS

(71) Applicant: NEC Laboratories America, Inc., Princeton, NJ (US)

(72) Inventors: Wei Cheng, Princeton Junction, NJ (US); Wenchao Yu, Plainsboro, NJ (US); Xuchao Zhang, Elkridge, MD (US); Haifeng Chen, West Windsor, NJ (US)

(21) Appl. No.: 18/311,984

(22) Filed: May 4, 2023

Related U.S. Application Data
(60) Provisional application No. 63/349,988, filed on Jun. 7, 2022.

(51) Int. Cl. H04L 41/16; H04L 41/142

(52) U.S. Cl. CPC H04L 41/16; H04L 41/142

(57) ABSTRACT

A computer-implemented method for personalizing heterogeneous clients is provided. The method includes initializing a federated modular network including a plurality of clients communicating with a server, maintaining, within the server, a heterogenous module pool having sub-blocks and a routing hypernetwork, partitioning the plurality of clients by modeling a joint distribution of each client into clusters, enabling each client to make a decision in each update to assemble a personalized model by selecting a combination of sub-blocks from the heterogenous module pool, and generating, by the routing hypernetwork, the decision for each client.

### RELATED APPLICATION INFORMATION

This application claims priority to Provisional Application No. 63/349,988 filed on Jun. 7, 2022, the contents of which are incorporated herein by reference in their entirety.

### BACKGROUND

### Technical Field

The present invention relates to personalized federated learning, and, more particularly, to personalized federated learning via heterogeneous modular networks.

### Description of the Related Art

Personalized Federated Learning (PFL) which collaboratively trains a federated model while considering local clients under privacy constraints has attracted much attention. Despite its popularity, it has been observed that existing PFL approaches result in sub-optimal solutions when the joint distribution among local clients diverges.

### SUMMARY

A method for personalizing heterogeneous clients is presented. The method includes initializing a federated modular network including a plurality of clients communicating with a server, maintaining, within the server, a heterogenous module pool having sub-blocks and a routing hypernetwork, partitioning the plurality of clients by modeling a joint distribution of each client into clusters, enabling each client to make a decision in each update to assemble a personalized model by selecting a combination of sub-blocks from the heterogenous module pool, and generating, by the routing hypernetwork, the decision for each client.

A non-transitory computer-readable storage medium comprising a computer-readable program for personalizing heterogeneous clients is presented. The computer-readable program when executed on a computer causes the computer to perform the steps of initializing a federated modular network including a plurality of clients communicating with a server, maintaining, within the server, a heterogenous module pool having sub-blocks and a routing hypernetwork, partitioning the plurality of clients by modeling a joint distribution of each client into clusters, enabling each client to make a decision in each update to assemble a personalized model by selecting a combination of sub-blocks from the heterogenous module pool, and generating, by the routing hypernetwork, the decision for each client.

A system for personalizing heterogeneous clients is presented. The system includes a processor and a memory that stores a computer program, which, when executed by the processor, causes the processor to initialize a federated modular network including a plurality of clients communicating with a server, maintain, within the server, a heterogenous module pool having sub-blocks and a routing hypernetwork, partition the plurality of clients by modeling a joint distribution of each client into clusters, enable each client to make a decision in each update to assemble a personalized model by selecting a combination of sub-blocks from the heterogenous module pool, and generate, by the routing hypernetwork, the decision for each client.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a block/flow diagram of an exemplary architecture for personalized federated learning, in accordance with embodiments of the present invention;

FIG. 2 is a block/flow diagram of exemplary applications of the architecture for personalized federated learning, in accordance with embodiments of the present invention;

FIG. 3 is a block/flow diagram of an exemplary architecture for personalized federated learning with heterogenous modular networks, in accordance with embodiments of the present invention;

FIG. 4 is a block/flow diagram of an exemplary workflow of the personalized federated learning architecture, in accordance with embodiments of the present invention;

FIG. 5 is a block/flow diagram of an exemplary workflow of the edge device components and local selected modules' components, in accordance with embodiments of the present invention;

FIG. 6 is a block/flow diagram of an exemplary workflow of the block-wise module parameters and the aggregated global parameters, in accordance with embodiments of the present invention;

FIG. 7 is a block/flow diagram of an exemplary processing system for personalizing heterogeneous clients, in accordance with embodiments of the present invention; and

FIG. 8 is a block/flow diagram of an exemplary method for personalizing heterogeneous clients, in accordance with embodiments of the present invention.

### DETAILED DESCRIPTION OF PREFERRED EMBODIMENTS

The huge quantity of data available nowadays is usually stored in the form of isolated islands. The barriers between data sources are usually difficult to break. In this context, Federated Learning (FL) emerges as a prospective solution that facilitates distributed collaborative learning without disclosing original training data whilst naturally complying with government regulations. FL works by collaboratively training a model under the orchestration of a central server (e.g., a service provider) while keeping the training data decentralized. Instead of aggregating the raw data to a centralized data center for training, FL leaves the raw data distributed on the client devices and trains a shared model on the server by aggregating locally computed updates, thus mitigating systemic privacy risks and costs resulting from conventional centralized machine learning approaches. Consequently, different clients share the same model structure and global model parameters.

In real applications, local data stored across devices are usually heterogeneous. The data may be distributed in a non-independently and identically distributed (e.g., non-IID) manner across multiple devices. In addition, some users may probably produce significantly more or less data than others. Moreover, the number of edge device owners may be significantly larger than the average number of training samples on each device. The problem of data heterogeneity deteriorates the performance of the global FL model on individual clients due to the lack of solution personalization. The global model shared across clients will not generalize well on a local distribution that is very different from the global distribution. To tackle this issue, researchers focus on Personalized Federated Learning (PFL), which aims to make the global model fit the distributions on most of the devices.

The conventional PFL approaches first learn a global model and then locally adapt it to each client by fine-tuning the global parameters. In this case, the trained global model can be regarded as a meta-model ready for further personalization of each local client. In order to build a better meta-model, many efforts have been made to bridge the FL and the Model Agnostic Meta Learning (MAML). However, the global generalization error usually does not decrease much for these approaches. Thus, the performance cannot be significantly improved. Another line of research focuses on jointly training a global model and a local model for each client to achieve personalization. This strategy does not perform well on the clients whose local distributions are far from their average. Cluster-based PFL approaches address this issue by grouping the clients into several clusters. The clients in a cluster share the same model while those belonging to different clusters have different models. Unfortunately, the model trained in one cluster will not benefit from the knowledge of the clients in other clusters, which limits the capability to share knowledge, and, therefore, results in a sub-optimal solution.

An alternative strategy is to adopt the Multi-Task Learning (MTL) framework to train a PFL model. However, some efforts are restricted to solve a convex objective due to the multi-task penalty. They are usually transformed into a dual problem to get a closed-form solution during the updating. Other MTL-based approaches are flexible to modern deep models and can be personalized to each client.

However, most existing efforts do not consider the difference in conditional distribution between clients, which is an important problem when building a federated model. For example, labels sometimes reflect sentiment. Some users may label a laptop as cheap while others may label the laptop as expensive. This conditional distribution heterogeneity problem will cause model inaccuracies on some clients where the p(y|x) is far from the average. To address the problem, recent works have assumed the data distribution of each client is a mixture of M underlying distributions and a flexible framework was proposed in which each client learns a combination of M shared components with different weights. It optimizes the varying conditional distribution pᵢ(y|x) under the assumption that the marginal distribution pᵢ(x)=p(x) is the same for all clients. This assumption, however, is problematic. For instance, in handwriting recognition, users who write the same words might still have different stroke widths, slants, etc. In this cases, pᵢ(x)≠pⱼ(x) for client i and j.

Other recent works either assume the marginal distribution pᵢ(X) or the conditional distribution pᵢ(y|x) the same across clients. In reality, data on each client may be deviated from being identically distributed, say, Pᵢ≠Pⱼ for client i and j. That is, the joint distribution Pᵢ(x,y) (can be rewritten as Pᵢ(y|x)Pᵢ(x) or Pᵢ(x|y)Pᵢ(y)) may be different across clients. This is referred to as the “joint distribution heterogeneity” problem. Existing approaches fail to completely model the difference of joint distribution between clients because they assume one term to be the same while varying the other one. Moreover, to accommodate different data distributions, the homogeneous model would be too large so that the given prediction power can be satisfied. Thus, the communication costs between the server and the clients would be huge. In this case, communication would be a key bottleneck to consider when developing FL methods. To this end, it is desirable to design an effective PFL model to accommodate heterogeneous clients in an efficient manner.

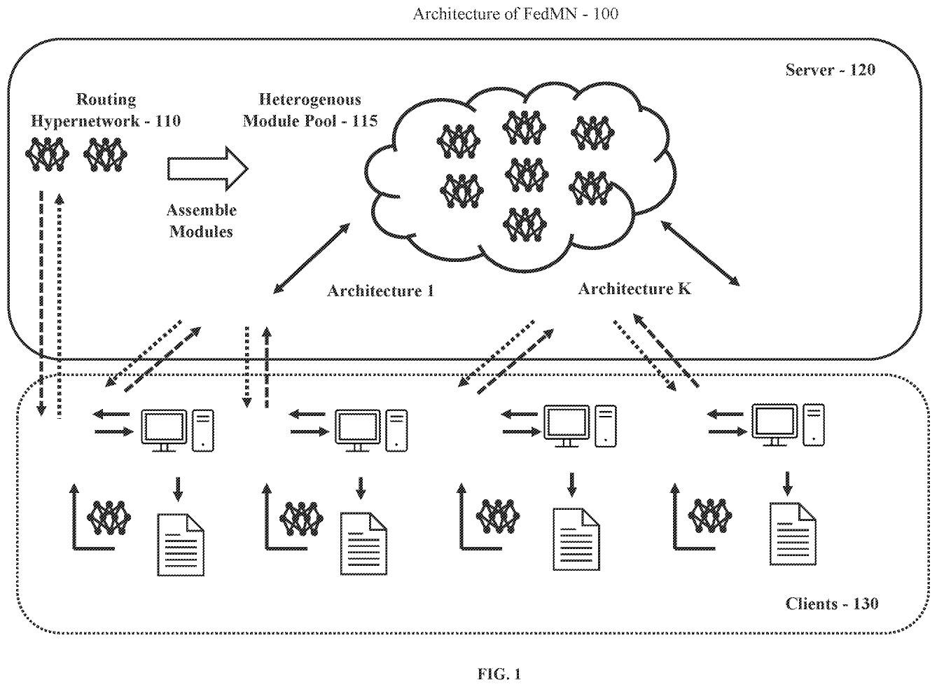

To solve the aforementioned issues, a Federated Modular Networks (FedMN) approach is presented, which personalizes heterogeneous clients efficiently. The main idea is that the exemplary methods implicitly partition the clients by modeling their joint distribution into clusters and the clients in the same cluster have the same architecture (FIG. 1). Specifically, a shared module pool 115 with layers of module blocks (e.g., MLPs or ConvNets) is maintained in the server 120. Each client 130 decides in each update to assemble a personalized model by selecting a combination of the blocks from the module pool 115. A light-weighted routing hypernetwork 110 with differentiable routers is adopted to generate the decision of module block selection for each client 130. The routing hypernetwork 110 considers the joint distribution pᵢ(x,y) for client i by taking the joint distribution of the data set as the input. A decision parameterized by the routing hypernetwork 110 is a vector of discrete variables following the Bernoulli distribution. It selects a subset of the blocks from the module pool 115 to form an architecture for each client 130. Clients with similar decisions will be implicitly assigned to the same cluster in each communication round. The proposed FedMN 100 enables a client 130 to upload only a subset of model parameters to the server 120, which decreases the communication burden compared to traditional FL algorithms.

To sum up, the contributions are as follows, that is, the problem of joint distribution heterogeneity in the personalized FL is addressed and a FedMN approach is presented to alleviate this issue. An efficient mechanism is devloped to selectively upload model parameters which decreases the communication cost between the clients 130 and the server 120.

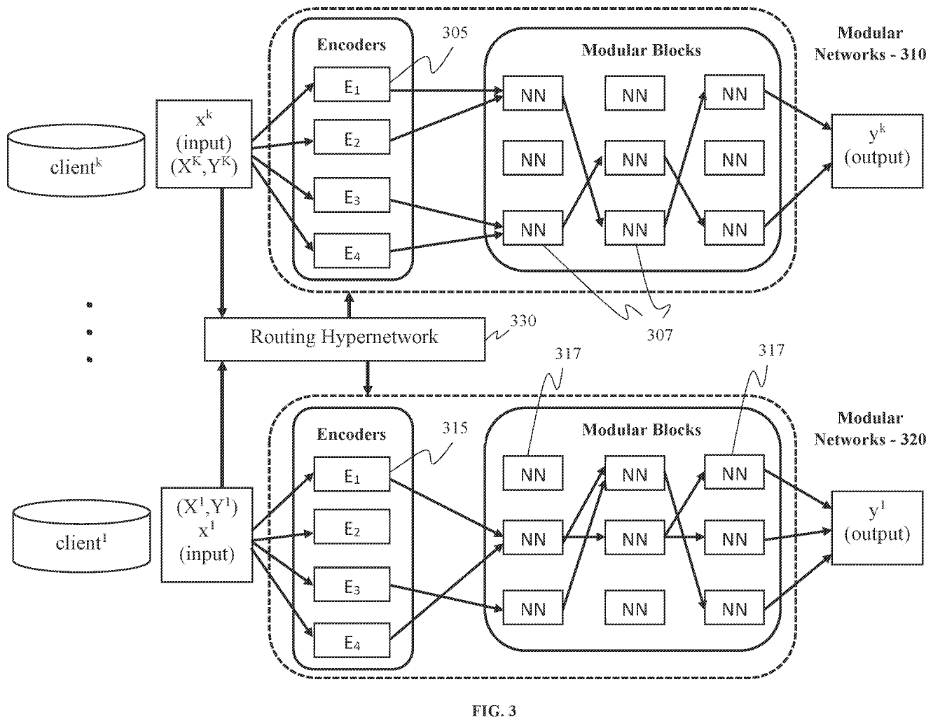

As shown in FIG. 3, FedMN 100 adopts modular networks 310, 320 which include a group of encoders 305, 315 in the first layer and multiple modular blocks 307, 317 in the following or subsequent layers. The connection decisions between blocks in the modular networks 310, 320 are made by a routing hypernetwork 330.

The modular networks 310, 320 first encode the data feature into low-dimensional embeddings by a group of encoders 305, 315. Then, personalized feature embeddings are obtained by discovering and assembling a set of modular blocks 307, 317 in different ways for different clients. The modular networks 310, 320 have L layers and the l-th layer has nₗ blocks of sub-networks. The encoders 305, 315 in the 1st layer are n₁ independent blocks which learn feature embeddings for each client.

Formally, let xᵢ be the i-th sample, and the feature embedding zᵢ^{(j)} is obtained after the j-th encoder is applied:

zᵢ^{(j)}=Encoder^{(j)}(xᵢ),j=1, . . . ,n₁ (1)

The choices of encoder networks are flexible. For example, convolutional neural networks (CNNs) can be adopted as encoders 305, 315 for image data and transformers for text data. The set of feature embeddings {zᵢ⁽¹⁾, . . . ,zᵢ⁽ⁿ^{₁}⁾} of data point X, resulting from the encoders 305, 315 in the 1st layer is the input of the following modular sub-networks constructed by a subset of the modular blocks 307, 317. There are L−1 layers of blocks in the sub-networks and each one is independent of the others. Each modular block j in layer l receives a list of tensors of feature embeddings from the modular sub-networks in the layer l−1.

MLPs are used as the modular blocks and each pair of them in successive layers may be connected or not. At most, there are E possible connection paths between modular blocks that can be calculated as follows:

ε=Σⱼ₌₁^{L-1}nⱼnⱼ₊₁+n_{L}. (2)

To determine which path would be connected, the exemplary methods need to learn a decision VₘϵZ₂^{E} for client m. Each element vᵢ^{(m)}ϵVₘ is a binary variable with values chosen from {0,1}. vᵢ^{(m)}=1 indicates that the path between two blocks is connected, and 0 otherwise. Since some blocks may not have connected paths, Vₘ also determines which subset of blocks will be selected from the modular pool 115 for each client 130 (FIG. 1). Therefore, after obtaining Vₘ, the architecture for a client 130 is determined.

With the defined modular networks, the exemplary methods can formally define the learning objective. Specifically, in a generic FL with M clients where each client has a local dataset Dₘ={(xᵢ,yᵢ)}ᵢ₌₁^{|D}^{ₘ}^{|}, the learning objective can be formulated by:

$${min}_{w} ℒ ( w ) = {\sum }_{m = 1}^{M} \frac{\vert {m}_{} \vert}{\vert \vert} {ℒ}_{m} ( w ) \\ where {L}_{m} ( w ) = \frac{1}{\vert {D}_{m} \vert} {\sum }_{( {x}_{i} , {y}_{i} ) ∈ {D}_{m}} ℓ ( {f}_{w} ( {x}_{i} ) , {y}_{i} ) . \qquad ( 3 )$$

Here, W is the model parameter, D=∪ₘDₘ is the aggregated data set from all clients, and Lₘ(w) is an empirical risk computed from client m's data. The objective in (3) is optimized by iterating between local training and global aggregation for multiple communication rounds. For generic FL, the exemplary methods perform ŷᵢ=ƒ_{w}(xᵢ) to make a prediction in the local updating.

In the FedMN framework, after getting Vₘ, the architecture of the modular network for client m is fixed at an epoch during local updating. The model ƒ can be parameterized by θ which includes parameters in modular networks 310, 320 and the routing hypernetwork 330.

When making a prediction, the exemplary methods have ŷᵢ=ƒ_{θ}(xᵢ; Vₘ). Then, it is easy to extend the generic FL to get the empirical risk of FedMN 100 as:

$${min}_{θ , {\{ {V}_{m} \}}_{m = 1}^{M}} {\sum }_{m = 1}^{M} \frac{\vert {m}_{} \vert}{\vert \vert} {ℒ}_{m} ( θ , {V}_{m} ) \\ where {L}_{m} ( θ , {V}_{m} ) = \frac{1}{\vert {D}_{m} \vert} {\sum }_{( {x}_{i} , {y}_{i} ) ∈ {D}_{m}} ℓ ( {f}_{θ} ( {x}_{i} ; {V}_{m} ) , {y}_{i} ) . \qquad ( 4 )$$

However, the direct optimization of the objective in (4) is intractable as there are 2^{E} candidates for each Vₘ. Thus, a relaxation is considered by assuming that the decision of each connection path in vᵢ^{(m)}ϵVₘ is conditionally independent to each other. Formally, it is given as:

$$P ( {V}_{m} ) = {\prod }_{{v}_{i}^{( m )} ∈ ℰ} P ( {v}_{i}^{( m )} ) . \qquad ( 5 )$$

A straightforward instantiation of P(vᵢ^{(m)}) is the Bernoulli distribution vᵢ^{(m)}:Bern (πᵢ^{(m)}). P(vᵢ^{(m)}=1)=πᵢ^{(m)} is the probability that the i-th path exists in Vₘ. With this relaxation, the objective in (4) can be rewritten as:

$$\begin{matrix}{min}_{θ , {\{ {V}_{m} \}}_{m = 1}^{M}} {\sum }_{m = 1}^{M} \frac{\vert {m}_{} \vert}{\vert \vert} {ℒ}_{m} ( θ , {V}_{m} ) = {\sum }_{m = 1}^{M} \frac{\vert {D}_{m} \vert}{\vert D \vert} {E}_{{v}_{m}} [ {L}_{m} ( θ , {V}_{m} ) ] \\ \approx {min}_{θ , {\{ {Π}_{m} \}}_{m = 1}^{M}} {\sum }_{m = 1}^{M} \frac{\vert {D}_{m} \vert}{\vert D \vert} \\ {E}_{{v}_{m} : q ( {Π}_{m} )} [ {L}_{m} ( θ , {V}_{m} ) ]\end{matrix} , \qquad ( 6 )$$

where q(Πₘ) is the distribution of the decision variable parameterized by π^{(m)}'s.

Due to the binary nature of Vₘ, it is impractical to optimize (6) with gradient-based back prorogation. To enable efficient computation, the exemplary methods further approximate the binary vector VₘϵZ₂^{E} with a continuous real-valued vector in [0,1]^{E}. In practice, the exemplary methods approximate each Bernoulli distribution vᵢ^{(m)}:Bern (πᵢ^{(m)}) with a binary concrete distribution.

Formally, letting σ(·) as the Sigmoid function, it is given as:

$${v}_{i}^{( m )} \approx σ ( ( log {o}^{‵} - log ( 1 - {o}^{‵} ) + log \frac{{π}_{i}^{( m )}}{1 - {π}_{i}^{( m )}} ) / τ ) , \\ where {o}^{‵} : Uniform ( 0 , 1 ) . \qquad ( 7 )$$

The hyper-parameter τ is a temperature variable to trade-off between approximation and binary output.

For justification, when the temperature τ approaches to 0, the binary concrete distribution of vᵢ^{(m)} in (7) converge to the Bernoulli distribution vᵢ^{(m)}:Bern(πᵢ^{(m)}). Specifically,

$$\begin{matrix}{lim}_{τ \to 0} P ( {v}_{i}^{( m )} = 1 ) = {lim}_{τ \to 0} P ( σ ( ( log {o}^{‵} - log ( 1 - {o}^{‵} ) + log \frac{{π}_{i}^{( m )}}{1 - {π}_{i}^{( m )}} ) / τ ) = 1 ) \\ = P ( log {o}^{‵} - log ( 1 - {o}^{‵} ) + log \frac{{π}_{i}^{( m )}}{1 - {π}_{i}^{( m )}} > 0 ) \\ = P ( log \frac{{o}^{‵}}{1 - {o}^{‵}} - log \frac{1 - {π}_{i}^{( m )}}{{π}_{i}^{( m )}} > 0 ) \\ = P ( \frac{{o}^{‵}}{1 - {o}^{‵}} > \frac{1 - {π}_{i}^{( m )}}{{π}_{i}^{( m )}} ) , for m ∈ [ M ]\end{matrix} .$$

Since ϵ and πᵢ^{(m)} both lies in (0,1), and function

$$\frac{x}{1 - x}$$

is monotonically increasing in this region.

Thus:

$${lim}_{τ \to 0} P ( {v}_{i}^{( m )} = 1 ) = P ( {o}^{‵} > 1 - {π}_{i}^{( m )} ) = {π}_{i}^{( m )} .$$

Therefore, with reparameterization, combining (6) and (7) the learning objective is given as:

$${min}_{θ , {\{ {Π}_{m} \}}_{m = 1}^{M}} {\sum }_{m = 1}^{M} \frac{\vert {m}_{} \vert}{\vert \vert} {\sim Uniform ( 0 , 1 )}_{} [ {ℒ}_{m} ( θ , {V}_{m} ) ] , \qquad ( 8 )$$

When temperature τ>0, the objective function in (8) has a well-defined gradient that enables efficient optimization with backpropagation.

The routing hypernetwork 330 that automatically learns Πₘ from the joint distribution is presented.

Suppose M clients are provided and such clients own local datasets D₁, . . . , D_{M}, where Dₘ={(x₁, y₁), . . . , (xₙ_{^{m}}, yₙ_{^{m}})} is a set of size n^{m} on client m. It is intended to obtain the joint n distribution embedding for each client. The kernel embeddings of joint distributions can be extended from that of the marginal distributions. Without loss of generality, a joint distribution P of variables X¹, . . . , X^{p} can be embedded into a p-th order tensor product feature space ⊗_{η=1}^{p}H^{η} as:

$$\begin{matrix}{{X}^{1 : p}}_{} ( P ) {=}^{△} {𝔼}_{{X}^{1 : p}} [ {⊗}_{η = 1}^{p} {ϕ}^{η} ( {X}^{η} ) ] \\ = {\int }_{{\times }_{η = 1}^{p} {Ω}^{η}} ( {⊗}_{η = 1}^{p} {ϕ}^{η} ( {x}^{η} ) ) dP ( {x}^{1} , … , {x}^{p} )\end{matrix} , \qquad ( 9 )$$

where X^{1:p} is a set of p variables {X¹, . . . , X^{p}} defined on x_{η=1}^{p}Ω^{η} [symbol] Ω¹x . . . xΩ^{p}, ϕ^{η} is the feature map of variable X^{η} endowed with kernel k^{η} in RKHS H^{η}, ⊗_{η=1}^{p}ϕ^{η}(x^{η}) [symbol] ϕ¹(x¹)⊗ . . . ⊗ϕ^{p}(x^{p}) is the feature map in the tensor product Hilbert space, where the inner product satisfies [symbol] ⊗_{η=1}^{p} ϕ^{η}(x^{η}), ⊗_{η=1}^{p}ϕ^{η}(x′^{η}) [symbol] =Π_{η=1}^{p}k^{η}(x^{η},x′^{η}). The joint embedding is an uncentered cross-covariance operator C_{X}_{^{1:p}} by the standard equivalence between tensor and linear map. In other words, the covariance of a set of functions ƒ¹, . . . , ƒ^{p} can be obtained by: E_{X}_{^{1:p}}[Π_{η=2}^{p}ƒ^{η}(X^{η})]= [symbol] ⊗_{η=1}^{p}ƒ^{η}, C_{X}_{^{1:p}} [symbol] .

To estimate the embeddings of distribution P (X¹, . . . ,X^{p}), finite samples can be used. For a sample set D_{X}_{^{1:p}}={x₁^{1:p}, . . . , xₙ^{1:p}} of size n which is drawn i.i.d. from P(X¹, . . . ,X^{p}), the joint embedding can be estimated empirically by:

$${{X}^{1 : p}}_{} = \frac{1}{n} {\sum }_{i = 1}^{n} {⊗}_{η = 1}^{p} {ϕ}^{η} ( {x}_{i}^{η} ) , \qquad ( 10 )$$

which converges to its population counterpart in RKHS norm. For instantiation, since the joint distribution on feature domain X is considered and domain Y is labeled for client m, m∈[M], the joint embedding is given as:

$${XY}_{} = \frac{1}{{n}^{m}} {\sum }_{i = 1}^{{n}^{m}} {ϕ}^{x} ( {x}_{i} ) {ϕ}^{y} ( {y}_{i} ) . \qquad ( 11 )$$

The mappings ϕ^{x}(X) and ϕ^{y}(y) are flexible. The tensor product ϕ^{x}(X)⊗ϕ^{x}(X) or higher order ones can be used, such as ϕ^{x}(X)⊗ϕ^{x}(X)⊗ϕ^{x}(X). θₕ is denoted as the parameters used in the routing hypernetwork, which is a part of the model parameters θ. The exemplary methods parameterize the feature mappings by employing neural networks, and thus the joint embedding estimator in (11) results in:

$${XY , {θ}_{h}}_{} = \frac{1}{{n}^{m}} {\sum }_{i = 1}^{{n}^{m}} {ϕ}_{{θ}_{h}}^{x} ( {x}_{i} ) {ϕ}_{{θ}_{h}}^{y} ( {y}_{i} ) . \qquad ( 12 )$$

Then, two fixed-size vector representations of a dataset are provided by the averaged output of the two neural networks: ϕ_{θ}_{ₕ}^{x}:x [symbol] R^{d}^{ₓ} and ϕ_{θ}_{ₕ}^{y}:y [symbol] R^{d}^{_{y}}. By the Universal Approximation Theorem, the exemplary methods concat ϕ_{θ}_{ₕ}^{x}(xᵢ) and ϕ_{θ}_{ₕ}^{y}(yᵢ) and adopt a single-layer perceptron h_{θ}_{ₕ}:R^{d}^{ₓ}^{+d}^{_{y}} [symbol] R^{E}, where E is the total possible number of paths between successive modulars as in (2), and, thus, the product operator in (12) can be approximated by:

$${{θ}_{h}}_{} ( X , Y ) = \frac{1}{{n}^{m}} {\sum }_{i = 1}^{{n}^{m}} {h}_{{θ}_{h}} ( [ {ϕ}_{{θ}_{h}}^{x} ( {x}_{i} ) , {ϕ}_{{θ}_{h}}^{y} ( {y}_{i} ) ] ) , \qquad ( 13 )$$

which results in a vector of joint embedding of the local dataset at client m.

Then, Πₘ can be obtained by:

$$\begin{matrix}{Π}_{m} = σ ( ( X , Y ) ) \\ = σ ( \frac{1}{{n}^{m}} {\sum }_{i = 1}^{{n}^{m}} {h}_{{θ}_{h}} ( [ {ϕ}_{{θ}_{h}}^{x} ( {x}_{i} ) , {ϕ}_{{θ}_{h}}^{y} ( {y}_{i} ) ] ) )\end{matrix} . \qquad ( 14 )$$

Since Vₘ determines the connection paths between blocks, some blocks may not have connections with other ones. To clarify the message passing between blocks, the connection paths between blocks in the layer (l−1) and the layer l are denoted as

$${C}_{m} ∈ {Z}_{2}^{{n}_{l} \times {n}_{l - 1}} ,$$

with the element Cⱼₖ^{(m)}∈{0,1} in its j-th row and k-th column.

Letting uⱼ^{(l)} be the input tensor for the j-th block in the layer l, and ũⱼ^{(l)} be its output:

$${u}_{j}^{( l )} = \{ \begin{matrix}\frac{{\sum }_{k = 1}^{{n}_{l - 1}} {c}_{jk}^{( m )} {\tilde{u}}_{k}^{( l - 1 )}}{{\sum }_{k = 1}^{{n}_{l - 1}} {c}_{jk}^{( m )}} , & if {\sum }_{k = 1}^{{n}_{l - 1}} {C}_{jk}^{( m )} \neq 0 , \\ 0 , & otherwise\end{matrix} . \qquad ( 15 )$$

To decrease the number of model parameters transmitted between clients and the server, a block-wise strategy is devloped for clients to upload the local models to the server and copy them from the server. In detail, when the decision Vₘ is obtained, it is known that the inputs for some blocks are 0's from (15). Therefore, some blocks are still active whose input is not all 0's. In total, it is denoted that there are B blocks in the modular network, where B=n₂+ . . . +nₗ. Let aₘ∈Z₂^{B} to denote which blocks are active for the local model at client m, with the element aᵢ^{(m)}=1 if the input for the i-th block is not 0 while aᵢ^{(m)}=0 otherwise. When uploading the model to the server, the client only uploads the active blocks whose aᵢ^{(m)}=1. When copying the model from the server, the client only copies the parameters of active blocks from the global model. This strategy significantly reduces unnecessary communication costs between clients and the server.

When all the clients upload their local models to the server, the server averages the model to get the global modules. In the proposed FedMN 100, the aggregation for the routing hypernetwork 110 is similar to FedAvg. For the modular networks 310, 320 of FIG. 3, the aggregation, however, is in a block-wise manner. Specifically, let θᵢ^{(m)} be the model parameters of the i-th modular block for client m, and the server performs the aggregation to obtain the global parameter of the i-th modular block θᵢ by:

$${θ}_{i} = {\sum }_{m = 1}^{M} \frac{\vert {𝒟}_{m} \vert}{\vert 𝒟 \vert} {a}_{i}^{( m )} {θ}_{i}^{( m )} . \qquad ( 16 )$$

The federated learning process of FedMN 100 is provided in Algorithm 1 below. The computation complexity in each round at each client in FedMN 100 is the same as that in FedAvg. The FedMN algorithm is a personalized FL method whose convergence is guaranteed.

Regarding the Federated Modular Networks Algorithm:

Input: Number of clients M; local dataset {Dₘ}ₘ₌₁^{M}, where Dₘ={(xᵢ, ydᵢ)}ᵢ₌₁^{|D}^{ₘ}^{|}; number of layers of modular network L; number of modular blocks in each layer {nₗ}ₗ₌₁^{L}; number of communication rounds T; number of local epochs K; learning rate η.

Output: Local models θₘ^{T} for m∈[M]; global model θ^{T}; local decisions Vₘ^{T} for m∈[M]. Server initializes the global modular pool {nₗ}ₗ₌₁^{L}.
iterations t=1, . . . , T clients m=1, . . . , M Get Πₘ with local dataset Dₘ as in (14); Vₘ←binaryConcrete (Πₘ) as in (7);
Determine the local model ƒ_{θ};
Client m copies θ^{t-1} from the server;
local epochs k=1, . . . ,K θ_{k,m}^{t-1}←LocalSolver (θ_{k-1,m}^{t-1}, Vₘ, η)
Client m sends θ_{K,m}^{t-1} to the server;
Server averages {θ_{K,m}^{t-1}}ₘ₌₁^{M} to get the global parameters θ^{t};
Compute the global loss as in (8);
Function LocalSolver(θₖ₋₁^{t-1}, Vₘ, η):
each batch

$$θ ← θ - η {∇}_{θ} {E}_{{V}_{m} : q ( {Π}_{m} )} [ {L}_{m} ( {θ}_{k}^{( t - 1 )} , {V}_{m} ) ] ;$$

return θ

The exemplary methods address the problem of joint distribution heterogeneity in the personalized FL. To tackle this issue, the exemplary methods propose a novel FedMN approach that adaptively assembles architectures for each client by selecting a subset of module blocks from a module pool in the global model. The proposed FedMN 100 adopts a light-weighted routing hypernetwork to model the joint distributions for each client and produce the module selection decisions. Advised by the decision, each client selects its personalized architecture. When federated updating, each client uploads, and downloads only part of the module parameters, which reduces the communication burden between the server and the clients.

FIG. 1 is a block/flow diagram of an exemplary architecture 100 for personalized federated learning, in accordance with embodiments of the present invention.

The routing hypernetwork 110 produces decisions for each of the clients 130. The clients 130 with similar decisions are grouped into the same cluster which copies the same subset of blocks as the local model from the module pool 115 in the server 120. After the local updating on each client 130, the clients 130 send their model parameters back to the server 120. The server 120 aggregates the model parameters block wisely, which results in a global model pool 115.

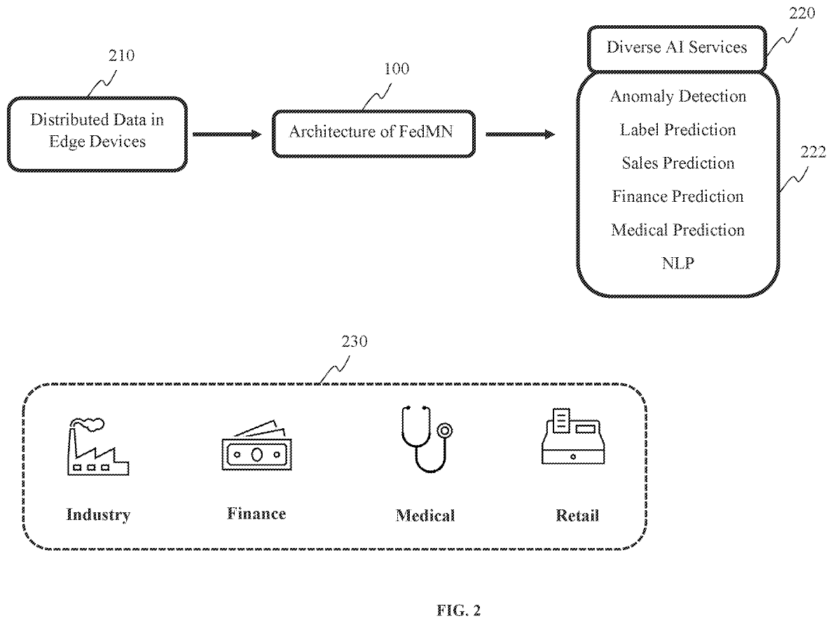

FIG. 2 is a block/flow diagram of exemplary applications of the architecture for personalized federated learning, in accordance with embodiments of the present invention.

There are various applications 230 for the proposed architecture 100 for personalized federated learning. For all general supervised or unsupervised learning tasks that includes edge devices 210 such as smartphones, sensors, radars, and so forth, the proposed architecture 100 can provide personalized prediction for edge devices, and at the same time, the prediction model can have the knowledge shared by other edge devices. The whole framework is privacy protected. The communication costs between edges are low. The diverse artificial intelligence (AI) services 220 provided can includes services 222, such as, anomaly detection, label prediction, sales prediction, finance prediction, medical prediction, natural language processing (NLP), etc.

FIG. 3 is a block/flow diagram of an exemplary architecture for personalized federated learning with heterogenous modular networks, in accordance with embodiments of the present invention.

The modular networks 310, 320 include a group of encoders 305, 315 in the first layer and modular blocks 307, 317 in the following layers. The connection paths between blocks are determined by a decision from the routing hypernetwork 330. The input of modular networks 310, 320 is in sample-wise while the input of routing hypernetwork 330 is the full dataset for each client.

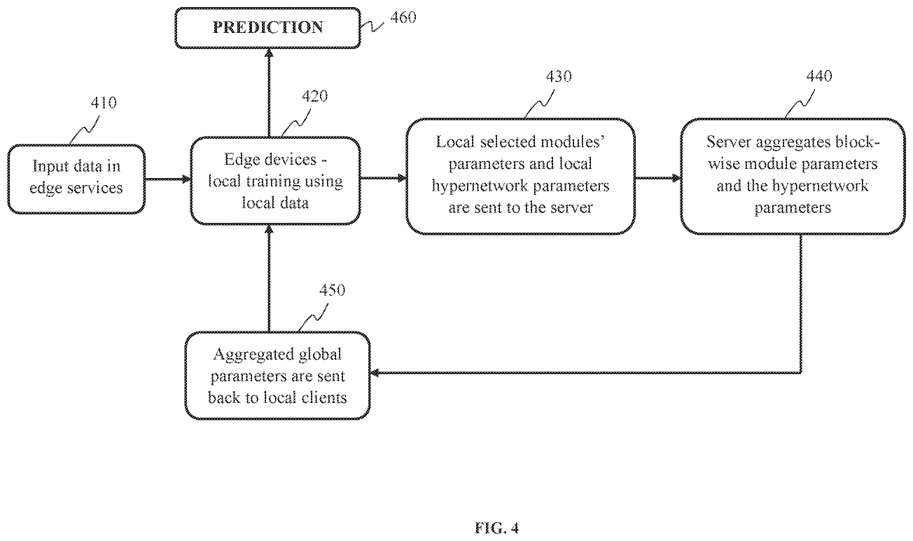

FIG. 4 is a block/flow diagram of an exemplary workflow of the personalized federated learning architecture, in accordance with embodiments of the present invention.

At block 410, input data in edge services.

At block 420, edge devices are locally trained by using local data.

At block 430, local selected modules' parameters and local hyper network parameters are sent to the server.

At block 440, the server aggregates block-wise module parameters and the hyper network parameters.

At block 450, the aggregated global parameters are sent back to local clients.

At block 460, a prediction is made.

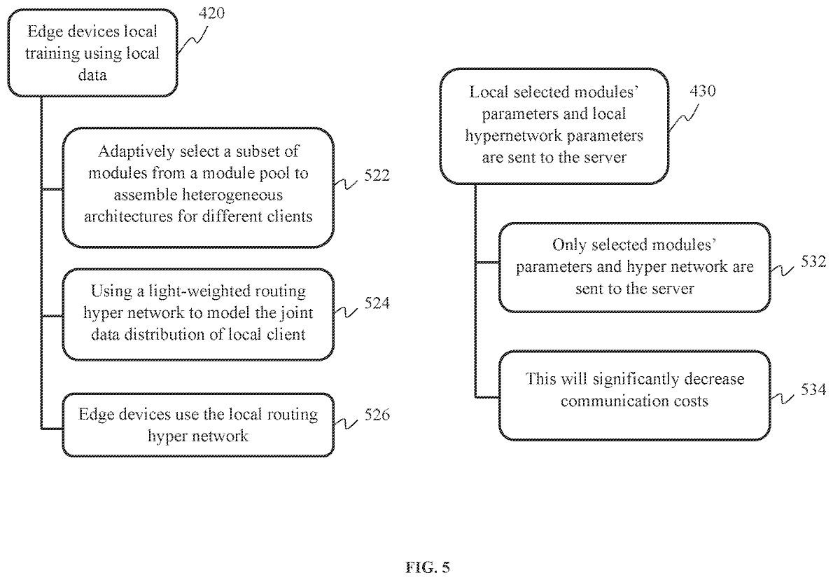

FIG. 5 is a block/flow diagram of an exemplary workflow of the edge device components and local selected modules' components, in accordance with embodiments of the present invention.

At block 420, edge devices are locally trained by using local data.

At block 522, adaptively select a subset of modules from a module pool to assemble heterogeneous architectures for different clients.

At block 524, use a light-weighted routing hyper network to model the joint data distribution of the local client.

At block 526, edge devices use the local routing hyper network.

At block 430, local selected modules' parameters and local hyper network parameters are sent to the server.

At block 532, only selected modules' parameters and hyper networks are sent to the server.

At block 534, it is noted that this will significantly decrease communication costs.

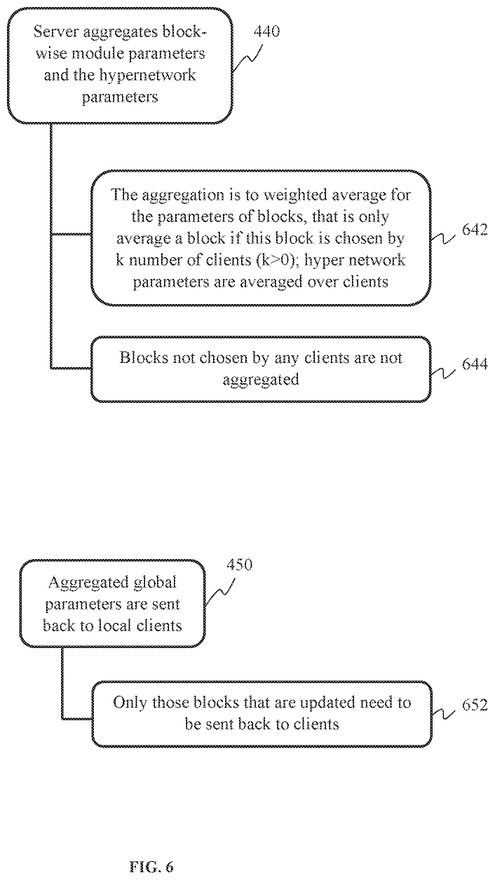

FIG. 6 is a block/flow diagram of an exemplary workflow of the block-wise module parameters and the aggregated global parameters, in accordance with embodiments of the present invention.

At block 440, the server aggregates block-wise module parameters and the hyper network parameters.

At block 642, the aggregation is to weighted average for the parameters of blocks, that is only average a block if this block is chosen by k number of clients (k>0); hyper network parameters are averaged over clients.

At block 644, blocks not chosen by any clients are not aggregated.

At block 450, the aggregated global parameters are sent back to local clients.

At block 652, only those blocks that are updated need to be sent back to the clients.

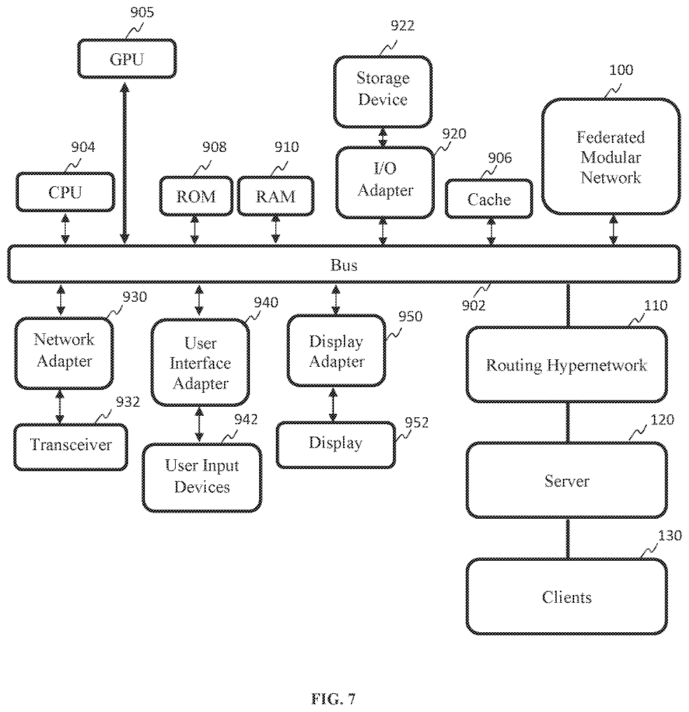

FIG. 7 is an exemplary processing system for personalizing heterogeneous clients, in accordance with embodiments of the present invention.

The processing system includes at least one processor (CPU) 904 operatively coupled to other components via a system bus 902. A GPU 905, a cache 906, a Read Only Memory (ROM) 908, a Random Access Memory (RAM) 910, an input/output (I/O) adapter 920, a network adapter 930, a user interface adapter 940, and a display adapter 950, are operatively coupled to the system bus 902. Additionally, the Federated Modular Network (FedMN) 100 is presented, a novel PFL approach that adaptively selects sub-modules from a module pool to assemble heterogeneous neural architectures for different clients. FedMN 100 adopts a light-weighted routing hypernetwork 110 to model the joint distribution on each client 130 and produce the personalized selection of the module blocks for each client 130. To reduce the communication burden in existing FL, an efficient way to interact between the clients 130 and the server 120 is developed.

A storage device 922 is operatively coupled to system bus 902 by the I/O adapter 920. The storage device 922 can be any of a disk storage device (e.g., a magnetic or optical disk storage device), a solid-state magnetic device, and so forth.

A transceiver 932 is operatively coupled to system bus 902 by network adapter 930.

User input devices 942 are operatively coupled to system bus 902 by user interface adapter 940. The user input devices 942 can be any of a keyboard, a mouse, a keypad, an image capture device, a motion sensing device, a microphone, a device incorporating the functionality of at least two of the preceding devices, and so forth. Of course, other types of input devices can also be used, while maintaining the spirit of the present invention. The user input devices 942 can be the same type of user input device or different types of user input devices. The user input devices 942 are used to input and output information to and from the processing system.

A display device 952 is operatively coupled to system bus 902 by display adapter 950.

Of course, the processing system may also include other elements (not shown), as readily contemplated by one of skill in the art, as well as omit certain elements. For example, various other input devices and/or output devices can be included in the system, depending upon the particular implementation of the same, as readily understood by one of ordinary skill in the art. For example, various types of wireless and/or wired input and/or output devices can be used. Moreover, additional processors, controllers, memories, and so forth, in various configurations can also be utilized as readily appreciated by one of ordinary skill in the art. These and other variations of the processing system are readily contemplated by one of ordinary skill in the art given the teachings of the present invention provided herein.

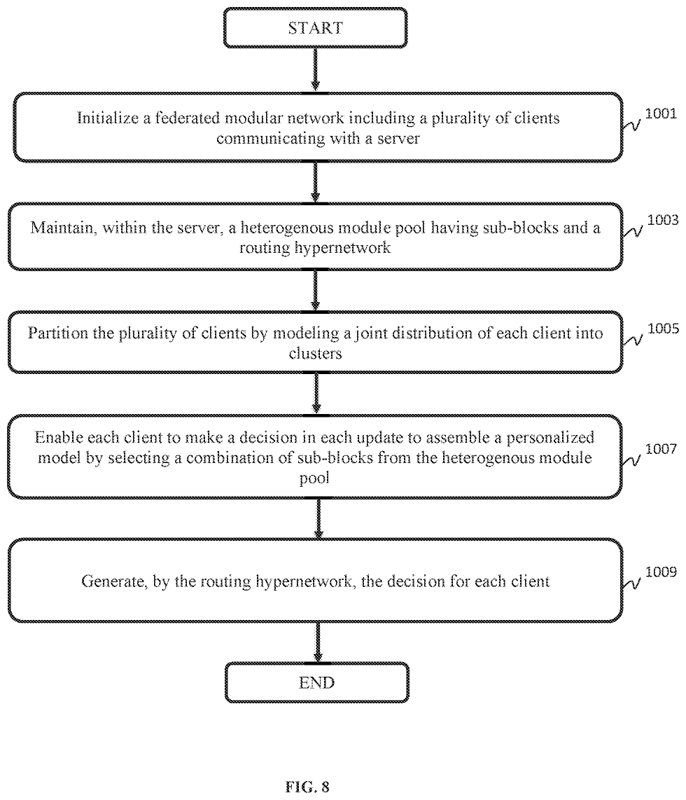

FIG. 8 is a block/flow diagram of an exemplary method for personalizing heterogeneous clients, in accordance with embodiments of the present invention.

At block 1001, initializing a federated modular network including a plurality of clients communicating with a server.

At block 1003, maintaining, within the server, a heterogenous module pool having sub-blocks and a routing hypernetwork.

At block 1005, partitioning the plurality of clients by modeling a joint distribution of each client into clusters.

At block 1007, enabling each client to make a decision in each update to assemble a personalized model by selecting a combination of sub-blocks from the heterogenous module pool.

At block 1009, generating, by the routing hypernetwork, the decision for each client.

As used herein, the terms “data,” “content,” “information” and similar terms can be used interchangeably to refer to data capable of being captured, transmitted, received, displayed and/or stored in accordance with various example embodiments. Thus, use of any such terms should not be taken to limit the spirit and scope of the disclosure. Further, where a computing device is described herein to receive data from another computing device, the data can be received directly from the another computing device or can be received indirectly via one or more intermediary computing devices, such as, for example, one or more servers, relays, routers, network access points, base stations, and/or the like. Similarly, where a computing device is described herein to send data to another computing device, the data can be sent directly to the another computing device or can be sent indirectly via one or more intermediary computing devices, such as, for example, one or more servers, relays, routers, network access points, base stations, and/or the like.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module,” “calculator,” “device,” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical data storage device, a magnetic data storage device, or any suitable combination of the foregoing. In the context of this document, a computer readable storage medium may be any tangible medium that can include, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the present invention. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks or modules.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks or modules.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks or modules.

It is to be appreciated that the term “processor” as used herein is intended to include any processing device, such as, for example, one that includes a CPU (central processing unit) and/or other processing circuitry. It is also to be understood that the term “processor” may refer to more than one processing device and that various elements associated with a processing device may be shared by other processing devices.

The term “memory” as used herein is intended to include memory associated with a processor or CPU, such as, for example, RAM, ROM, a fixed memory device (e.g., hard drive), a removable memory device (e.g., diskette), flash memory, etc. Such memory may be considered a computer readable storage medium.

In addition, the phrase “input/output devices” or “I/O devices” as used herein is intended to include, for example, one or more input devices (e.g., keyboard, mouse, scanner, etc.) for entering data to the processing unit, and/or one or more output devices (e.g., speaker, display, printer, etc.) for presenting results associated with the processing unit.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that those skilled in the art may implement various modifications without departing from the scope and spirit of the invention. Those skilled in the art could implement various other feature combinations without departing from the scope and spirit of the invention. Having thus described aspects of the invention, with the details and particularity required by the patent laws, what is claimed and desired protected by Letters Patent is set forth in the appended claims.

What is claimed is:

1. A computer-implemented method for personalizing heterogeneous clients, the method comprising:
initializing a federated modular network including a plurality of clients communicating with a server;
maintaining, within the server, a heterogenous module pool having sub-blocks and a routing hypernetwork;
partitioning the plurality of clients by modeling a joint distribution of each client into clusters;
enabling each client to make a decision in each update to assemble a personalized model by selecting a combination of sub-blocks from the heterogenous module pool; and
generating, by the routing hypernetwork, the decision for each client.

2. The computer-implemented method of claim 1, wherein the federated modular network adopts modular networks including a group of encoders in a first layer and multiple modular blocks in subsequent layers.

3. The computer-implemented method of claim 2, wherein connection decisions between the multiple modular blocks in the modular networks are made by the routing hypernetwork.

4. The computer-implemented method of claim 1, wherein the decision that is parameterized by the routing hypernetwork is a vector of discrete variables following a Bernoulli distribution.

5. The computer-implemented method of claim 1, wherein each client with similar decisions is assigned into a same cluster in each communication round.

6. The computer-implemented method of claim 1, wherein each client uploads only a subset of model parameters to the server to decrease a communication cost between the plurality of clients and the server.

7. The computer-implemented method of claim 1, wherein, when copying the personalized model from the server, a client of the plurality of clients only copies parameters of active blocks from a global model to reduce unnecessary communication costs between the plurality of clients and the server.

8. A computer program product for personalizing heterogeneous clients, the computer program product comprising a non-transitory computer readable storage medium having program instructions embodied therewith, the program instructions executable by a computer to cause the computer to perform a method comprising:
initializing a federated modular network including a plurality of clients communicating with a server;
maintaining, within the server, a heterogenous module pool having sub-blocks and a routing hypernetwork;
partitioning the plurality of clients by modeling a joint distribution of each client into clusters;
enabling each client to make a decision in each update to assemble a personalized model by selecting a combination of sub-blocks from the heterogenous module pool; and
generating, by the routing hypernetwork, the decision for each client.

9. The computer program product of claim 8, wherein the federated modular network adopts modular networks including a group of encoders in a first layer and multiple modular blocks in subsequent layers.

10. The computer program product of claim 9, wherein connection decisions between the multiple modular blocks in the modular networks are made by the routing hypernetwork.

11. The computer program product of claim 8, wherein the decision that is parameterized by the routing hypernetwork is a vector of discrete variables following a Bernoulli distribution.

12. The computer program product of claim 8, wherein each client with similar decisions is assigned into a same cluster in each communication round.

13. The computer program product of claim 8, wherein each client uploads only a subset of model parameters to the server to decrease a communication cost between the plurality of clients and the server.

14. The computer program product of claim 8, wherein, when copying the personalized model from the server, a client of the plurality of clients only copies parameters of active blocks from a global model to reduce unnecessary communication costs between the plurality of clients and the server.

15. A computer processing system for personalizing heterogeneous clients, comprising:
a memory device for storing program code; and
a processor device, operatively coupled to the memory device, for running the program code to:
initialize a federated modular network including a plurality of clients communicating with a server;
maintain, within the server, a heterogenous module pool having sub-blocks and a routing hypernetwork;
partition the plurality of clients by modeling a joint distribution of each client into clusters;
enable each client to make a decision in each update to assemble a personalized model by selecting a combination of sub-blocks from the heterogenous module pool; and
generate, by the routing hypernetwork, the decision for each client.

16. The computer processing system of claim 15, wherein the federated modular network adopts modular networks including a group of encoders in a first layer and multiple modular blocks in subsequent layers.

17. The computer processing system of claim 16, wherein connection decisions between the multiple modular blocks in the modular networks are made by the routing hypernetwork.

18. The computer processing system of claim 15, wherein the decision that is parameterized by the routing hypernetwork is a vector of discrete variables following a Bernoulli distribution.

19. The computer processing system of claim 15, wherein each client with similar decisions is assigned into a same cluster in each communication round.

20. The computer processing system of claim 15, wherein each client uploads only a subset of model parameters to the server to decrease a communication cost between the plurality of clients and the server.
